(19) United States
(12) Patent Application Publication
(10) Pub. No.: US 2012/0089591 A1
(43) Pub. Date: Apr. 12, 2012

(54) SELF-INDUCED ONLINE QUERY REPLY SYSTEM

(76) Inventor: Abraham Stern, San Jose (CR)

(21) Appl. No.: 13/267,069

(22) Filed: Oct. 6, 2011

Related U.S. Application Data
(60) Provisional application No. 61/392,297, filed on Oct. 12, 2010.

(51) Int. Cl. G06F 17/30

(52) U.S. Cl. 707/710; 707/E17.109

(57) ABSTRACT

A new network communications tool that allows third parties (companies, individuals, and others) to recognize if a certain user is looking for products or services that they might offer. Providing that the user expressly authorizes it, this new communication system will send an automated communication to various companies or individuals indicating that the user is looking for products or services offered by them and that the user is willing to receive direct information from them.

### CROSS REFERENCE TO RELATED APPLICATION

This application is based upon and claims benefit of copending and co-owned U.S. Provisional Patent Application Ser. No. 61/392,297 entitled “Self-Induced Online Query Reply System”, filed with the U.S. Patent and Trademark Office on Oct. 12, 2010 by the inventor herein, the specification of which is incorporated herein by reference.

### BACKGROUND

1. Field of the Invention

This invention relates to a revolutionary reply system concept for the Internet and, more particularly, to a reply system concept that enables a direct communication scheme for offerors and willing recipients using the World Wide Web or other communication network to obtain personalized and selective results.

2. Description of the Background

Given the gigantic amount of information that circulates over the Internet on a daily basis, marketing products, services, and the like through this medium has become a problematic task. Thus, it is necessary to create a new marketing tool that will effectively position those companies and individuals on the Internet. Today, people who use the Internet as a tool to advertise, offer or sell their products, services and others, have essentially four “basic” vehicles available to achieve their immediate marketing objectives:
1. Search Engines
2. Internet Directories
3. Solicited Mail; and
4. Unsolicited Mail (commonly known as SPAM)

While it is contemplated that other marketing vehicles may be available over the Internet, such fact does not exclude the innovation and originality of the present invention.

Without search engines systems, it would be almost impossible to limit and control the vast amount of information and Internet material that is available to users in the World Wide Web. All search engines have a common characteristic; a “description space” in which a user inputs the type of information he is looking for and the engine retrieves the information using the engine's own methodology indicated in the “description space” as a parameter to display results. (See FIG. 1.)

Search engines represent a valuable tool for Internet users, but may present a hassle for those corporations or individuals that use the Internet as a marketing tool. Plainly speaking, if a company or an individual does not appear in the first two or three result pages, chances are that most of the users will never get a real chance to visit the company's website and find out the type of products, services and others offered. These can be called “forgotten sites”, and for companies having one of these, search engines do not provide an immediate viable Internet marketing tool for their products or services.

Internet Directories are small custom-made search engines or systems that have been created for certain types of industries, professions, services, or products. It is common to find on the World Wide Web all type of Internet Directories that go from the well-known yellow pages to directories for a specific profession or industry. These directories also represent a valuable marketing tool for the products and services but do not eliminate the problem previously indicated. The main disadvantage of these directories is that the results are delivered using alphabetical or numerical parameters to generate their results. As such, if the name of a company, product or service begins with the letter “E”, all those companies, products, or services that begin with the letters “A”, “B”, “C” or “D” have a beforehand positioning advantage with respect to company “E”. From this perspective, it would be imprudent and unadvisable to promote products and services if the name of the company starts with the wrong letter or number.

More importantly, the companies or individuals who offer their products or services through these directories do not have a direct contact with the user or any control whatsoever on how he or she handles the information generated by the directory. In spite of paying to be part of an Internet Directory, the companies or individuals always lack the direct contact or bonding with the user, who, at the end of his or her search, will choose a company, product, or service, not based on an objective criteria but on the manner by which the results are randomly displayed by the system.

To fix this commercially unbalanced defect, many directories apply a “sort by” formula, but independent of how the results are sorted there will always be a fortunate first and an unlucky last.

In view of the deficiencies previously indicated, companies and individuals who use the Internet as a marketing instrument have been forced to find alternatives for marketing that are not available through Search Engines or Internet Directories. With the massive amount of information that circulates in the Internet and the speed with which this information is handled, many companies and individuals use massive systems of electronic communications that circulate around the world in a matter of seconds covering a gigantic number of users.

Solicited and unsolicited e-mails are part of such massive electronic communication systems that are used on a daily basis by those companies and individuals that have failed to position their products and services by using traditional search engines and Internet directories.

A rough definition of unsolicited e-mails or SPAM is any email sent against the will, interest, and knowledge of the recipient, usually with no intention of a response other than to visit a website or to sell a product. These emails are usually sent out in large numbers and to many recipients, knowing in advance that only a small portion of users will actually consider it.

On the other hand, solicited e-mail includes the massive characteristics of unsolicited e-mails but in which the user has “accepted”, sometimes inadvertently, to receive this type of information. This acceptance is usually concealed, since the same is automatically generated by registering a product or subscribing to a specific site that contains a pre-checked authorization to received future communications.

Both solicited and unsolicited e-mails give companies and individuals the power to overcome the unbalanced market conditions actually available in search engines and Internet Directories by approaching their prospective clients or users in a direct way. At first, solicited and unsolicited e-mails look like a valuable alternative for Internet marketing but at the end of the day, it merely transfers the hassle to the users who are often obligated to purchase anti-SPAM software. Moreover, it has been proven that this type of marketing has a very low success rate and often undervalues and diminishes the image of the offered brand, industry, profession, service, or product.

### SUMMARY

Accordingly, it is an object of the present invention to provide a self-induced reply system that avoids the disadvantages of the prior art.

It is another object of the present invention to provide a method for obtaining meaningful, targeted results from search queries.

It is another object of the present invention to enable a direct and personalized communications scheme for offerors and willing recipients using the World Wide Web. It is a related object of the present invention to enable a direct and personalized communications scheme for offerors and willing recipients using a computer implemented communication network. A related object of the present invention is to provide users with the option to let third parties know the type of online query he is looking for and to allow those third parties to communicate directly with the user regarding its query.

It is another object of the present invention to provide users with a personalized, temporary, disposable e-mail address to provide confidentiality and to protect the users' identity. A related object of the present invention is to provide users with a personalized, temporary, disposable e-mail address in order to enable control of the amount and quality of information generated by the companies' and individuals' replies.

It is another object of the present invention to provide users with a web site in which they can check their inquiries and responses from offerors. It is a related object of the present invention to create a network channel in which both offerors and recipients can establish direct communications, using regular emails, chat, video conference and any other available mechanisms.

It is another object of the present invention to enable a system in which users can rate the services or products rendered by the offerors, creating an open forum in which any user would be able expose his experience with the different offerors.

### BRIEF DESCRIPTION OF THE DRAWINGS

The above and other features, aspects, and advantages of the present invention are considered in more detail, in relation to the following description of embodiments thereof shown in the accompanying drawings, in which:

FIG. 1 is a flow chart showing current search methodology on the World Wide Web;

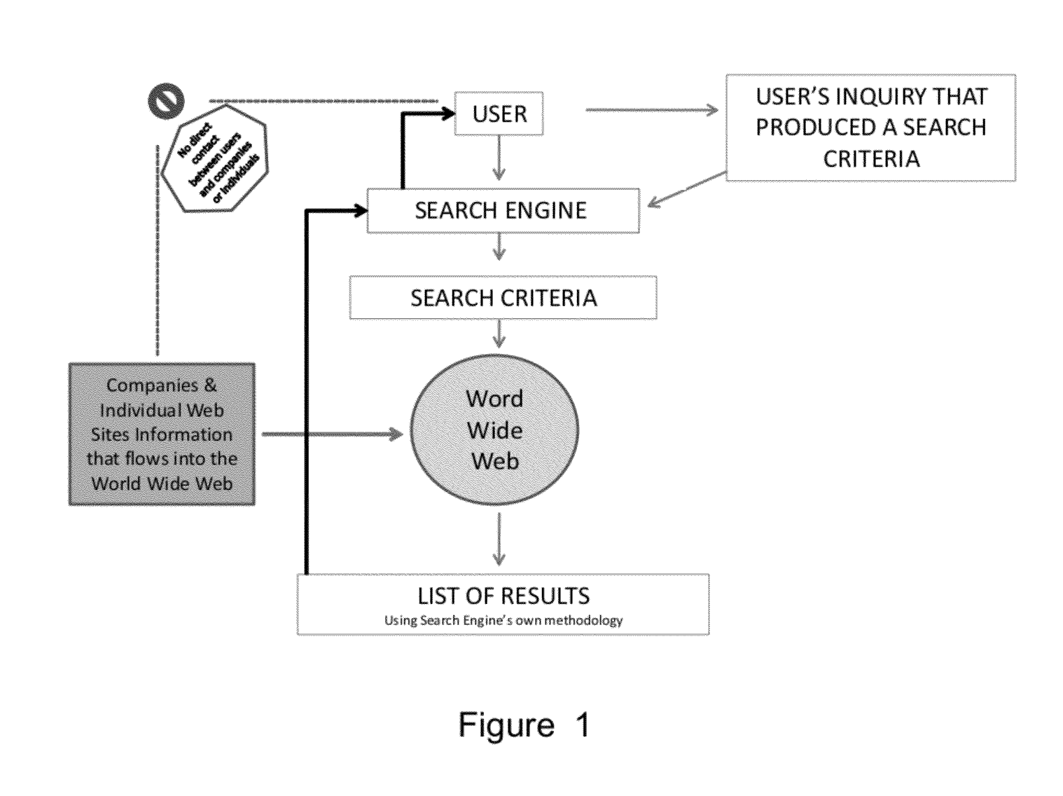

FIG. 2 is a flow chart showing a self-induced reply system methodology according to a first embodiment of the present invention; and

FIG. 3 is a flow chart showing a self-induced reply system methodology according to a variation of the first embodiment of the present invention using an alternate communication means.

### DETAILED DESCRIPTION OF EXEMPLARY EMBODIMENTS

The invention summarized above and defined by the enumerated claims may be understood by referring to the following description, which should be read in conjunction with the accompanying drawings. This description of an embodiment, set out below to enable one to build and use an implementation of the invention, is not intended to limit the invention, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form, including existing or future communication mechanisms such as wide area or small area networks, Social Media, mobile applications, among others.

The resolution to the marketing problem previously described above is solved by creating a new communication tool that allows third parties (companies, individuals, or others) to recognize if a certain user is looking for products, services or others they might offer. Providing that the user expressly authorizes it, this new system will send an automated communication to various companies or individuals indicating that the user is looking for products or services offered by them and that the user is willing to receive direct information from them.

To create a fair, equal, and healthy competition for all companies, individuals, and others that use the Internet as a marketing tool, it is necessary to create a self-induced reply system as a new Internet marketing tool. This self-induced reply system is the innovative element of the present invention and it will revolutionize the way marketing is handled throughout the Internet. While the specific embodiment described below is directed toward communication using networked computers over the Internet, it is contemplated that the system described herein may be implemented using hand-held devices, portable applications, wide area or small area networks, etc.

The self-induced reply system operates similar to a regular search engine or internet directory with the following differences:
A) The initial page will have sections saved for the exclusive use of the user and other sections saved for the exclusive use of companies, individuals, and others who offers products and services;
B) The user executes an inquiry authorizing the system to notify compatible companies and individuals about the inquiry and letting them know that the user is willing to receive direct information from them;
C) Instead of having only one description space, the initial page may also have several descriptive spaces by means of which both the user and the company, individuals, and others offering products or services could indicate in a more precise and exact manner the type of information the user is looking for and the type of product or service the company or individual is offering, respectively. The number of descriptive spaces is not critical to the function of the present invention.

This new range of “sections” will serve as filters to specifically identify the type of product and service the user is looking for, and to create a unique database of companies and individuals who provide those products and services.

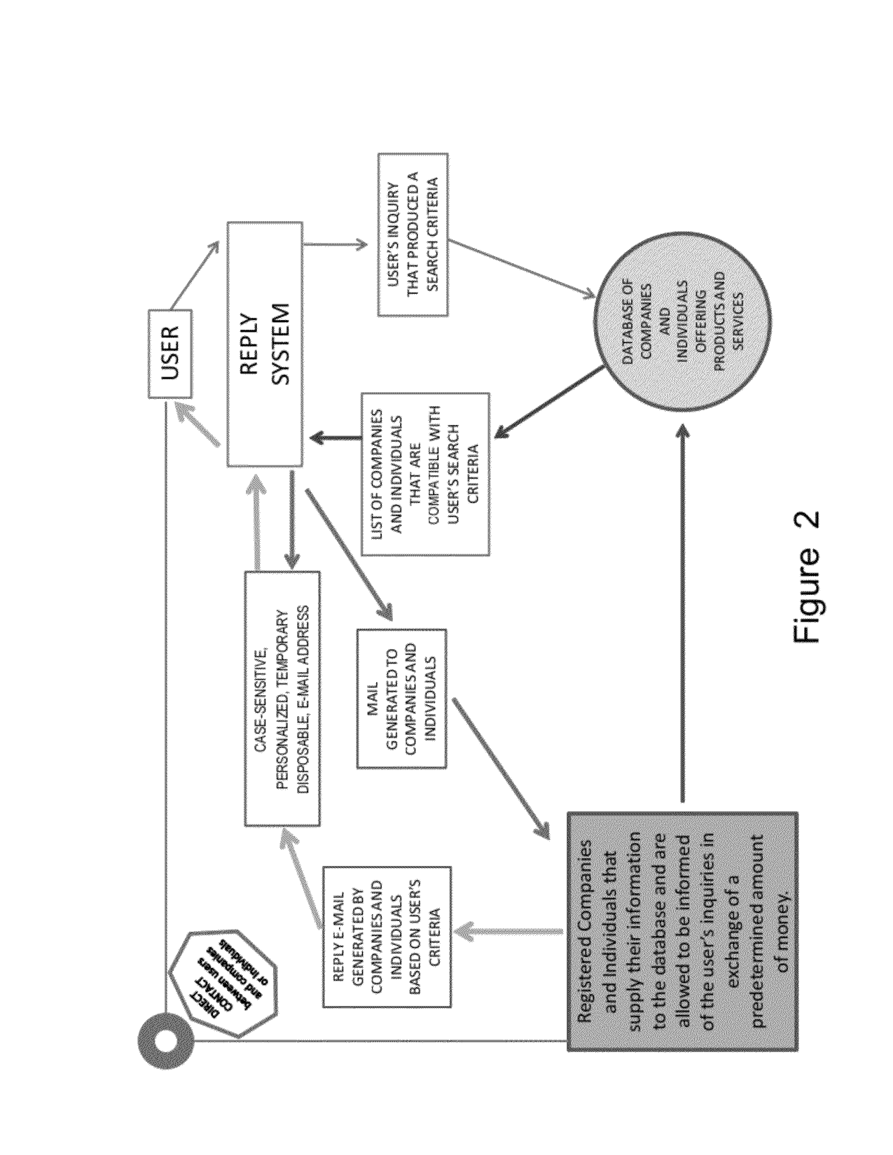

FIG. 2 shows a flow chart of the self-induced reply system methodology according to a first embodiment of the present invention. As an example, and with the sole purpose of understanding how this new concept operates, the initial page of the self-induced reply system (to be used exclusively by the users), may have one or several of the following description spaces. (The number, name and/ or nature of the descriptive spaces that may be use under this new concept does not disqualify the innovation and originality of the present invention.):
1. Type of service or product the user is searching for.
2. Area or Specialization.
3. Geographical area.
4. Number of replies the user is willing to receive.
5. Additional comments/requirements.
   a. Any of the spaces could consist of a predetermined list of choices or be left open to the user's choice.
6. User communication address.
   a. In a preferred embodiment, an e-mail address will be given by the self-induced reply system for no cost to the user. Although, in a preferred embodiment an e-mail for the user may be provided by the self-induced reply system, it is also possible to execute the present concept with any type of existing e-mail addresses. The type of e-mail address to be used does not disqualify the innovation and originality of the present invention.
   b. In a preferred embodiment, the engine will automatically produce a personalized, temporary, disposable e-mail address for each inquiry. By doing so, the engine can protect the users' identity and control the amount and quality of information generated by the companies' and individuals' replies.
   c. The idea behind the self-induced reply system providing a personalized, temporary, disposable e-mail address for each inquiry is to provide full confidentiality, to protect the user identity, to control the number of replies as explained below and to expel from the system those companies and individuals that breach the policies of the system.
   d. In some embodiments, the user's communication address may correspond to a text messaging account, a social media handle (such as a Twitter™ name or FaceBook™ account), etc.

Preferably, if the user has previously had a bad experience with a vendor, the user may indicate one or more specific entities that the user does not desire to receive any bids from. In some embodiments, such selection should be maintained in strict confidence by the system. Alternatively, the system can allow users to rate the services or products rendered by the offerors and share such information with other users, creating an open forum in which any user would be able describe his experience with the different offerors

On the other hand, the initial page of the self-induced reply system (to be used exclusively by the companies and individual offering products or services), may have one or several of the following description spaces. (As above, the number, name and/or nature of descriptive spaces that may be use under this new concept does not disqualify the innovation and originality of the present invention.)
1. Type of service or product offered by the company or individual.
2. Area of specialization offered by the company or Individual.
3. Geographic Area within which the company or individual is offering its products or services.
4. Physical address of the company or individual offering products or services.
5. E-mail of the company or individual offering products or services.
6. Name of the officer of the company or person who is responsible for offering the products or services.
7. Method of payment.
   a. Any of the spaces could consist of a predetermined list of choices or be left open to the user's choice.

In a preferred embodiment, all the companies and individuals offering products and services should register previously in the system and may be required to pay a pre-established amount of money to be entitled to receive information from the self-induced reply system. The amount to be paid can be set on weekly, monthly, or annual basis; by mail received or sent, or structured in any way that satisfies the economic interests of the system operator. This innovative system can also be used free of charge for the companies and individuals and be funded by advertising and other economic means. Preferably, users will only have to make a limited-registration to facilitate the creation of the personalized, temporary, disposable e-mail address and the service will be free of charge. When the user authorizes the system to send an automated communication to various companies, individuals, and others indicating that he or she is looking for products or services offered by them, and that he or she is willing to receive replies from them, then and only then, the system will automatically generate a case sensitive personalized, temporary, disposable e-mail address that will allow the user to receive communications from companies, individuals, and others, without exposing the user's identity.

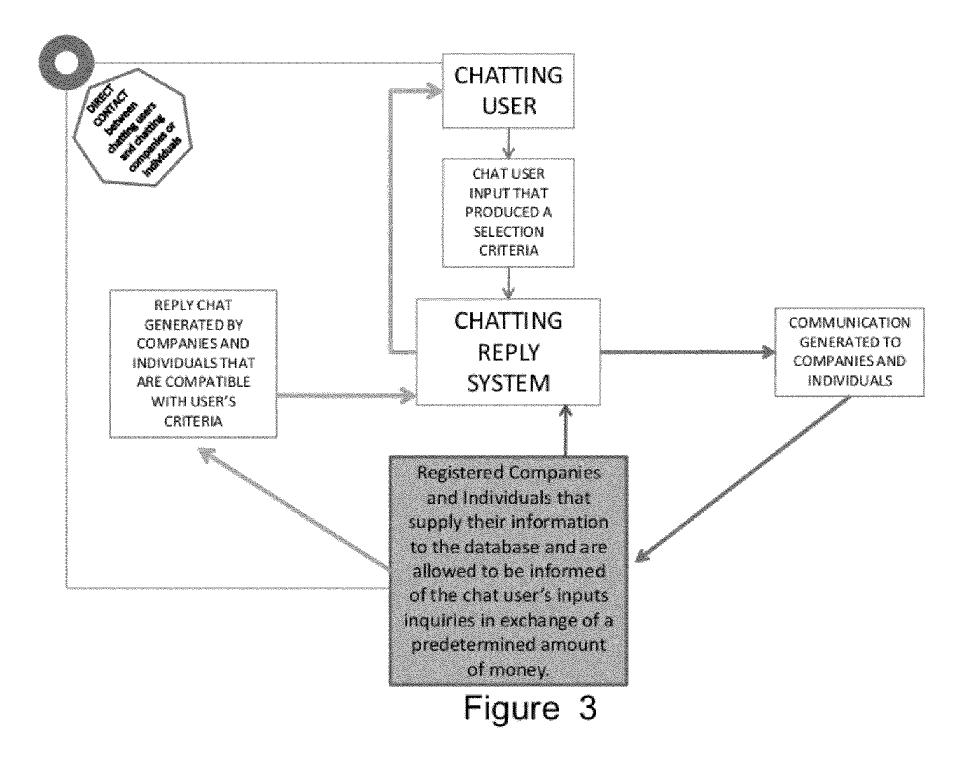

While it is envisioned that the most likely communication method may be via email, it is further contemplated that other means of communication, such as voice telephone, text messaging, social messaging, video conferencing, etc. may be used between the user and selected vendor (see FIG. 3).

The below example is provided for the purpose of explaining the mechanics of the system. Consider that a User in New York is looking for a real estate lawyer in Costa Rica. On the initial page of the self-induced reply system (to be used exclusively by users), the user inputs the following information:
Type of Service: Legal
Area or Specialization: Real Estate
Geographical area: Costa Rica
Additional comments: I have beachfront property in Guanacaste, Costa Rica and need legal assistance for sale.

The user can also use a single description space and write: “Real Estate Legal Services for property located in Guanacaste, Costa Rica”

Once the user has completed the descriptive spaces, he should mark the record indicating: “I authorize the system, to inform compatible companies and individuals about my search inquiry and to allow them to contact me directly.” (This example of the text authorizing the system to communicate to third parties has been provided as an example only. The use of different texts or words does not does not disqualify the innovation and originality of the present invention.)

If the user does not mark the authorization, the self-induced reply system simply displays the list of results in the same manner as a search engine or and internet directory. Although in a preferred embodiment, the use of this new system may be associated in conjunction with operating search engines and internet directories, it is also possible to use the self-induced reply system independently or in conjunction with any other type of communication vehicles such as Chatting Software (see FIG. 3), VOIP Systems including video conference programs, and Social Networks, among other.

However, if the user does mark the authorization, then the page shows two additional sections:
Please reply regarding my search to the following e-mail address (as previously indicated, in a preferred embodiment this e-mail address will be automatically generated using a case-sensitive, personalized, temporary, disposable e-mail):
johndoe@inquiry12376xyz.com
I will only accept a maximum of ______ replies or answers.

In a preferred embodiment, the user can limit the number of replies the user is willing to receive. The use of a limit to the numbers of replies does not disqualify the innovation and originality of the present invention and, as such, a user may opt to receive unlimited numbers of replies.

Once this information is completed, the system automatically generates a message with the information contained in the descriptive spaces and sends the message to all the registered companies, individuals, and others that match and are compatible with the User's inquiry criteria. The message may be sent by e-mail, text, or other appropriate means.

In the above example, the generated message would be sent to all registered law firms and lawyers with offices in Costa Rica that specializes in Real Estate Law. From that moment on, the user just has to wait to receive the number of replies that he had previously authorized. Once the user receives the maximum authorized number of replies, the system automatically rejects any further replies and the case sensitive, personalized, temporary, disposable e-mail address is deleted from its database. In some embodiments, the personalized e-mail may be retained for a specified period or indefinitely.

A user can consider bids from offerors either as information is received, as first come-first served, or once the maximum number of authorized answers is received. It is important to note that the user does not need to wait to receive all the replies. With such selectivity in his power, the user then analyses the received information, and can freely and voluntarily contact those companies and individuals that suit his interest.

With this innovative system, the Internet marketing control is transferred from randomly generated mechanisms to an objective direct control of the companies, individual, and others who offers products and services. Subscribed companies or individuals may rely on their own answer efficiency and capabilities to capture new clients. As such, the user would not have to choose from a subjective predetermined list but from a well-educated election, based on the content and quality of replies presented by the different companies and individuals offering products and services. Furthermore, the system allows an offeror to reply not only with email or texts but also by using other formats such as PDF's, Videos, Power Point Presentations, and other means or formats actually known or that may be developed in the future, having information specifically directed to the user's query.

Although, in preferred embodiment the response time may not be immediate, the system has the advantage of allowing the user to receive direct information from a safe source and to evaluate the different companies and individual who offer their products and services by the time, presentation, and content of their answers.

The invention has been described with references to a preferred embodiment. While specific values, relationships, materials, and steps have been set forth for purposes of describing concepts of the invention, it will be appreciated by persons skilled in the art that numerous variations and/or modifications may be made to the invention as shown without departing from the spirit or scope of the basic concepts and operating principles of the invention. It should be recognized that, in the light of the above teachings, those skilled in the art could modify those specifics without departing from the invention taught herein. Having now fully set forth the preferred embodiments and certain modifications of the concept underlying the present invention, various other embodiments as well as certain variations and modifications of the embodiments herein shown and described will obviously occur to those skilled in the art upon becoming familiar with such underlying concept. It is intended to include all such modifications, alternatives and other embodiments insofar as they come within the scope of the invention or equivalents thereof. It should be understood, therefore, that the invention might be practiced otherwise than as specifically set forth herein. Consequently, the present embodiments are to be considered in all respects as illustrative and not restrictive.

What is claimed is:

1. A method for providing personalized communication between offerors and willing recipients, such method comprising the steps of:
receiving a user query requesting specific information, wherein said query comprises a one or more terms or phrases entered by the user into a search engine webpage or internet directory and said query including a specific authorization for compatible entities to view the query and respond directly to the user;
notifying compatible entities that can be responsive to the user query about the query; and
passing user contact information to the compatible entities meeting predetermined criteria.

2. The method according to claim 1 wherein the query is rendered over a global computer network.

3. The method according to claim 2 wherein the global computer network comprises the Internet.

4. The method of claim 1 wherein said user contact information comprises an email address.

5. The method of claim 1, further comprising generating a temporary email address for said user.

6. The method of claim 5 wherein said email address is disposable.

7. The method of claim 1 wherein said predetermined criteria includes a limit to the number of responses to be received by the user.

8. The method of claim 1, further comprising determining compatible entities according to user input.

9. An improved search engine or internet directory for controlling response to online queries comprising:
a server coupled to a network of computers operative to
receive user search queries from a client device requesting specific information,
notify compatible entities that can be responsive to the user query about the query, and
pass user contact information to the compatible entities meeting predetermined criteria
a computer implemented database for storing data about companies and individuals offering products and services, said computer implemented database being operatively linked to said server;
a computer for retrieving data from said computer implemented database; said computer being operatively linked to said server; and
a rule engine executing on the computer that is operable to generate a list of companies and individuals compatible with the user search query.

10. The improved search engine or internet directory of claim 9, said server further operative to determine compatible entities according to user input.

11. The improved search engine or internet directory of claim 9, said server further operative to generate an email address for said user.

12. The improved search engine or internet directory of claim 11 wherein said email address is temporary and disposable.

13. The improved search engine or internet directory of claim 9 wherein the server is coupled to a global computer network.

14. The improved search engine or internet directory of claim 13 wherein the global computer network comprises the Internet.

15. The improved search engine or internet directory of claim 9, said server further operative to generate a page for said user having one or more descriptive spaces for entering query information by the user.

16. The improved search engine or internet directory of claim 15 wherein said one or more descriptive spaces comprise a predetermined list of choices.

17. The improved search engine or internet directory of claim 9, said server further operative to generate a page for use by companies and individuals offering products and services, said page having one or more descriptive spaces for entering information about the company or individual.
